(19) United States
(12) Patent Application Publication
(10) Pub. No.: US 2024/0305486 A1
(43) Pub. Date: Sep. 12, 2024

(54) Method of Managing Non-Fungible Token

(71) Applicant: TOYOTA JIDOSHA KABUSHIKI KAISHA, Toyota-shi Aichi-ken (JP)

(72) Inventors: Tomokazu ISHII, Okazaki-shi Aichi-ken (JP); Kuniaki MURAKAMI, Nagoya-shi Aichi-ken (JP); Koji HETSUGI, Nagoya-shi Aichi-ken (JP); Naoki ISHIHARA, Nisshin-shi Aichi-ken (JP); Tatsuya OWASHI, Nagoya-shi Aichi-ken (JP)

(73) Assignee: TOYOTA JIDOSHA KABUSHIKI KAISHA, Toyota-shi Aichi-ken (JP)

(21) Appl. No.: 18/438,968

(22) Filed: Feb. 12, 2024

(30) Foreign Application Priority Data
Mar. 6, 2023 (JP) 2023-033465

(51) Int. Cl. H04L 9/00; G06Q 30/0601

(52) U.S. Cl. CPC H04L 9/50; G06Q 30/0609

(57) ABSTRACT

A plurality of second articles are obtained from a first article by changing a manner of storage of the first article. A method of managing an NFT includes: managing a first NFT associated with the first article, the first NFT being issued using distributed ledger technology; and managing a plurality of second NFTs respectively associated with the plurality of second articles, the plurality of second NFTs being issued to each correspond to the first NFT using the distributed ledger technology. The managing of the first NFT includes recording first sensor data obtained by the first sensor, in association with the first NFT. The managing of the plurality of second NFTs includes recording second sensor data obtained by the second sensor, in association with the plurality of second NFTs.

### CROSS REFERENCE TO RELATED APPLICATIONS

This nonprovisional application is based on Japanese Patent Application No. 2023-033465 filed on Mar. 6, 2023 with the Japan Patent Office, the entire contents of which are hereby incorporated by reference.

### BACKGROUND

### Field

The present disclosure relates to a method of managing non-fungible tokens.

### Description of the Background Art

Recently, attention has been paid to a non-fungible token (NFT). Non-fungible tokens are one kind of tokens issued (mint) using a distributed ledger technology such as a block chain technology. Falsification of non-fungible tokens is extremely difficult. Thus, a non-fungible token may be associated with an article and used as a certificate that certifies authorization for the article (e.g., ownership of the article).

Japanese Patent Application Laid-Open No. 2022-45382 discloses a management system for management of storage status data and proof of ownership of a liquor barrel such as a whisky to be traded in units of barrels. The system associates the basic data of the barrel, the positional information of the barrel, and the storage state data of the barrel with the barrel number, hashes them, and records them on a public block chain.

### SUMMARY

However, the inventors of the present case have found that the system described in PTL 1 has the following problem. A manner of storage of the article may be changed in its production process (or may be changed in its distribution process). For example, in the example of the above-described liquor barrel, the liquor stored in the barrel may be divided into small portions (bottled). The above-described system is configured to monitor the state of the article in a consistent manner. Therefore, when the manner of storage is changed in this way, it is difficult to trace the state of the article back to its state before the manner of storage is changed. The system has room for improvement in view of low traceability for an article changed in a manner of storage.

The present disclosure has been made to solve the above-described problem, and one object of the present disclosure is to improve traceability for an article proved to have an authority by a non-fungible token when a manner of storage of the article is changed.

In a method of managing a non-fungible token (NFT) for an article according to a certain aspect of the present disclosure, the article includes a first article and a plurality of second articles. The plurality of second articles are obtained from the first article by changing a manner of storage of the first article. The first article is monitored by a first sensor. Each of the plurality of second articles is monitored by a second sensor. The method of managing the NFT includes: managing a first NFT associated with the first article, the first NFT being issued using distributed ledger technology; and managing a plurality of second NFTs respectively associated with the plurality of second articles, the plurality of second NFTs being issued to each correspond to the first NFT using the distributed ledger technology. The managing of the first NFT includes recording first sensor data obtained by the first sensor, in association with the first NFT. The managing of the plurality of second NFTs includes recording the second sensor data obtained by the second sensor, in association with the plurality of second NFTs.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing an overall configuration of an NFT trading market according to an embodiment of the present disclosure.

FIG. 2 is a diagram showing an example of a configuration of an information processing system according to an embodiment of the present disclosure.

FIG. 3 is a diagram illustrating a sensor system for collecting sensor data.

FIG. 4 is a conceptual diagram for explaining a manufacturing process of the wine.

FIG. 5 is a diagram showing an example of a data structure of an NFT according to the present embodiment.

FIG. 6 is a conceptual diagram showing an example of a method of handling NFT according to the present embodiment.

FIG. 7 is a sequence chart showing a processing procedure relating to an evaluation expression for evaluating wine.

FIG. 8 is a sequence chart showing a processing procedure relating to an NFT transaction.

FIG. 9 is a sequence chart showing the NFT issuing process in more detail.

### DESCRIPTION OF THE EMBODIMENTS

Hereinafter, embodiments of the present disclosure will be described in detail with reference to the accompanying drawings. In the drawings, the same or corresponding parts are denoted by the same reference numerals, and description thereof will not be repeated.

### Embodiments

In the following embodiments, an example in which the “article” according to the present disclosure is a wine will be described. The “article” according to the present disclosure is not particularly limited as long as the manner of storage is changed in the manufacturing process and/or the distribution process. The “article” according to the present disclosure may be other beverages (e.g. alcohols such as whiskers) or food products.

### NFT Trading Market

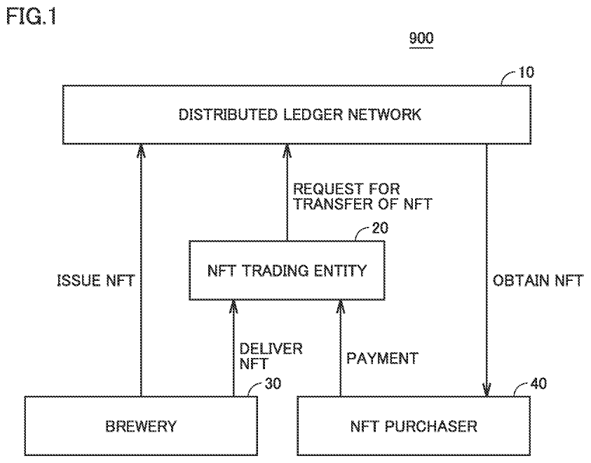

FIG. 1 is a diagram showing an overall configuration of an NFT trading market according to an embodiment of the present disclosure. The NFT trading market 900 is configured to trade an NFT that proves authorization (e.g., ownership) for an article. The NFT trading market 900 includes a distributed ledger network 10, an NFT trading entity 20, a brewery 30, and a plurality of NFT purchasers 40.

The distributed ledger network 10 manages NFT using distributed ledger technology. In the following, an example in which a block chain is used as a distributed ledger technology will be described. However, the distributed ledger technology is not limited to the block chain, and may be other technologies such as CORDA®.

The NFT trading entity 20 is an operator that operates the NFT market place. The NFT market place is a platform for trading various NFTs. In the NFT market place, the NFT is typically traded (purchased) with virtual currency.

The brewery 30 is an operator who brews wine. The brewery 30 produces wine from raw materials, stores the produced wine in a barrel, and bottles the stored wine. The brewery 30 requests the distributed ledger network 10 to issue an NFT for certifying the authority of the wine manufactured by the brewery 30. Further, the brewery 30 delivers the issued NFT to the NFT trading entity 20.

When the NFT desired to be purchased is delivered to the NFT market place, the NFT purchaser 40 makes a decision on the NFT market place. The NFT market place requests the distributed ledger network 10 to transfer the NFT of interest to the NFT purchaser 40 upon receipt of a payment from the NFT purchaser 40. In response to a request from the NFT market place, the distributed ledger network 10 transfers the NFT to the NFT purchaser 40.

### System Configuration

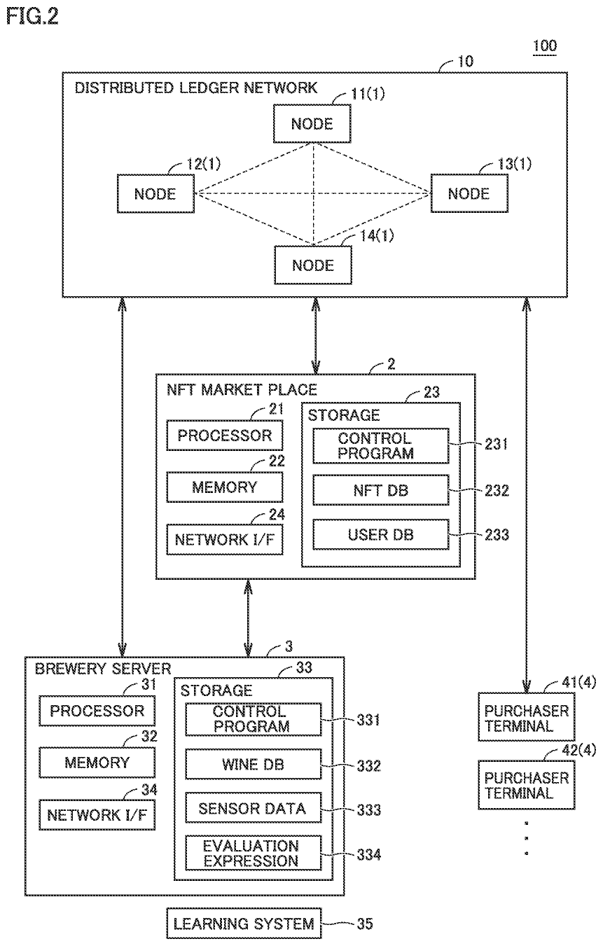

FIG. 2 is a diagram showing an example of a configuration of an information processing system according to an embodiment of the present disclosure. The information processing system 100 includes a distributed ledger network 10, an NFT market place 2, a brewery server 3, and a plurality of purchaser terminals 41 and 42 (referred to as purchaser terminal 4).

The distributed ledger network 10 is a public block chain network. The distributed ledger network 10 includes a plurality of (four in this example) nodes 11 to 14 for convenience of the drawing. The number of nodes is not particularly limited as long as it is 2 or more, but usually is much larger than 4. When the nodes 11 to 14 are not distinguished from each other, they are referred to as “node 1”. Block chain-based software is introduced into each node 1. A plurality of nodes 11 to 14 communicate with each other via a network to form a block chain network. Each node 1 holds a distributed ledger that records a history of transaction data for the NFT.

The NFT market place 2 is operated by the NFT trading entity 20 and mediates the transaction of the NFT. The NFT market place 2 includes a processor 21, a memory 22, storage 23, and a network interface 24. The components of the NFT market place 2 are communicably connected to each other by a communication bus.

The processor 21 is an arithmetic processing unit such as a CPU (Central Processing Unit) or an MPU (Micro-Processing Unit). The memory 22 is a volatile memory such as a random access memory (RAM). The storage 23 is a rewritable nonvolatile memory such as an HDD (Hard Disk Drive), an SSD (Solid State Drive), or a flash memory. The storage 23 stores a system program (not shown) including an OS (Operating System), a control program 231 including computer-readable codes necessary for control operation, an NFT database 232 for managing NFTs, and a user database 233 for managing users (public and purchasers of NFTs). The storage 23 may store a distributed ledger.

The processor 21 reads out the system program and the control program 231, develops them in the memory 22, and executes them, thereby realizing various processes. For example, the processor 21 receives an NFT output from the brewery server 3 and a NFT purchase request from the purchaser terminal 4. At this time, the processor 21 confirms the authority (owner of the NFT) relating to the wine by referring to the distributed ledger held in the node 1 of the distributed ledger network 10. The network interface 24 controls data communication between the NFT market place 2 (processor 21) and other devices (distributed ledger network 10, brewery server 3, purchaser terminal 4, etc.).

The brewery server 3 is operated by the brewery 30, and manages data and authority related to wine. The brewery server 3 includes a processor 31, a memory 32, a storage 33, and a network interface 34. The components of the brewery server 3 are communicably connected to each other by a communication bus.

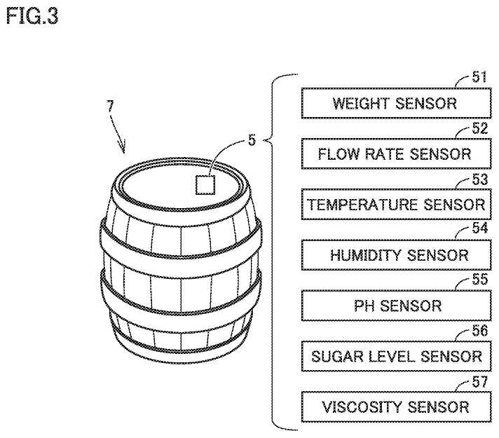

The processor 31 is an arithmetic processing unit such as a CPU or an MPU. The memory 32 is a volatile memory such as a RAM. The storage 33 is a rewritable non-volatile memory such as an HDD, SSD, or flash memory. The storage 33 stores a system program (not shown) including an OS, a control program 331 including computer-readable codes necessary for control operation, a wine database 332 for managing wines, sensor data 333 collected using the sensor system 5 (see FIG. 3) and an evaluation expression 334 (described later) for quantitatively evaluating the wines. The storage 33 may store a distributed ledger.

A learning system 35 is connected to the brewery server 3. The learning system 35 is used for machine learning of the evaluation expression 334 (details will be described later). The learning system 35 may be a component of the brewery server 3.

The processor 31 reads out the system program and the control program 331, develops them in the memory 32, and executes them, thereby realizing various processes. For example, the processor 31 requests the distributed ledger network 10 to issue the NFT when changing the manner of storage of the wine. Further, the processor 31 quantitatively evaluates the wine by substituting appropriate sensor data into the evaluation expression 334. The network interface 34 controls data communication between the brewery server 3 (processor 31) and other devices (distributed ledger network 10, NFT market place 2, etc.).

In this specification, the “processor” is not limited to a narrow processor that executes processing by a stored program method, and may include a hard-wired circuit such as ASIC (Application Specific Integrated Circuit), FPGA (Field-Programmable Gate Array). Thus, the term “processor” may be interpreted as processing circuitry that is predefined by computer-readable code and/or hardwired circuitry.

Each of the plurality of purchaser terminals 4 is operated by a purchaser (purchaser) of the NFT. The purchaser may be a general user (wine favorite) or a purchaser of a wine. The purchaser terminal 4 is a terminal such as a smartphone, a tablet, or a personal computer (PC). The purchaser terminal 4 is configured to be able to communicate data with other apparatuses (the distributed ledger network 10, the NFT market place 2, etc.).

### Sensor Data

FIG. 3 is a diagram illustrating a sensor system 5 for collecting sensor data 333. The sensor system 5 is provided inside the barrel 7, for example, in order to monitor the stored state of the wine inside the barrel 7. The sensor system 5 includes, for example, a weight sensor 51, a flow rate sensor 52, a temperature sensor 53, a humidity sensor 54, a pH sensor 55, a sugar level sensor 56, and a viscosity sensor 57.

The weight sensor 51 measures the total weight of the barrel 7 (the total weight of the empty barrel 7 and the remaining amount of wine). The flow rate sensor 52 measures the flow rate of wine flowing out from the faucet when the faucet of the barrel 7 is opened. The temperature sensor 53 measures the temperature of the inner space of the barrel 72. The humidity sensor 54 measures the humidity of the inner space of the barrel 72. The pH sensor 55 measures the PH of the wine. The sugar level sensor 56 measures the sugar level of wine. The viscosity sensor 57 measures the viscosity of the wine. Each sensor outputs the measurement result to the brewery server 3. The brewery server 3 stores the result of measurement by the sensor system 5 as sensor data 333. In some embodiments, the brewery server 3 stores a time stamp indicating the acquisition time of the sensor data 96 together with the sensor data 333.

A part of these sensors may be provided in the storage of the barrel 7. For example, the outside air temperature may be measured by the temperature sensor 53, or the outside air humidity may be measured by the humidity sensor 54. The sensor system 5 may include a taste sensor (not shown) instead of or in addition to some sensors (pH sensor 55, sugar level sensor 56, viscosity sensor 57, etc.). Taste sensors measure, for example, the acid taste, salt taste, umami taste, sweetness and bitter taste of wine.

In this example, the sensor data regarding the wine stored in the barrel has been described. Although the detailed description will not be repeated, some sensor data (e.g., data related to weight, temperature, humidity, etc.) may be obtained even at the stage of material. Sensor data (e.g., data related to weight, temperature, humidity, pH, sugar level, viscosity, etc.) can also be obtained for the bottled wine.

### Preservation of Wine

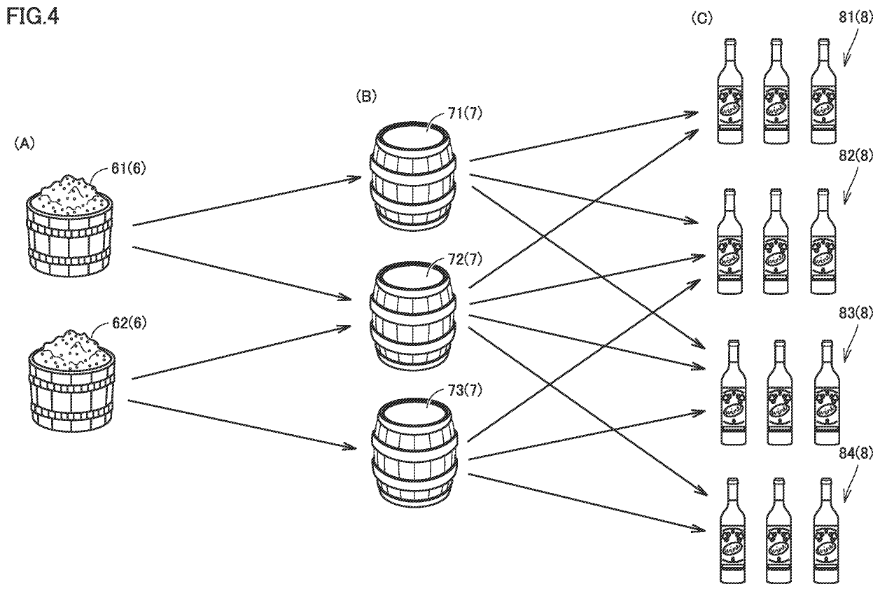

FIG. 4 is a conceptual diagram for explaining a manufacturing process of the wine. An outline of a typical manufacturing process of wine is as follows. The brewery 30 harvests and crushes wine materials 61 and 62 (referred to as crushed material 6) (black grapes, white grapes, etc.) (see portion (A) of FIG. 4). In the brewery 30, the crushed material is placed in barrels (which may be tanks made of stainless steel) 71 to 73 and fermented under temperature control (see portion (B) of FIG. 4). Further, the brewery 30 performs stabilization treatment (starching and starching) of wine after the fermentation. The brewery 30 may be sterilized and filtered in addition to the stabilization process. The wine after the stabilization treatment is aged in the barrel. Then, the brewery 30 blends a plurality of kinds of wines (Different types of grapes, those cultivated in different areas of the same grapes, those produced in different years, and the like.) aged in different barrels to perform bottle packing in wine bottles 81, 82, 83, and 84 (referred to as wine bottles 8) (see portion (C) of FIG. 4). The bottled wine bottles 8 are then stored until shipment.

The wine fermented in the barrel can be from different materials. Also, wine fermented in the same barrel is bottled in a large number of bottles. Further, the bottled wine may be a blend of multiple types of wine fermented in different barrels. Thus, wine may change its preservation mode in the manufacturing process. In the system disclosed in PTL 1, when the manner of storage is changed, it is difficult to track the state of the wine back before the manner of storage is changed. It is also desirable to improve traceability for wine whose manner of storage is changed.

Therefore, in the present embodiment, the brewery server 3 issues the NFT before the manner of storage is changed and the NFT after the manner of storage is changed, and associates the two NFTs with each other. Hereinafter, the NFT for proving the authorization for the material of the wine is referred to as “material NFT”. An NFT for certifying the authority for wine in a state stored in a barrel is referred to as a “barrel NFT”. An NFT for certifying authorization for a wine in a bottled state is referred to as a “bottle NFT”. As described in detail below, the brewery server 3 associates the barrel NFT and the bottle NFT with each other, for example. The brewery server 3 may correspond the material NFT and the barrel NFT to each other. Thus, even if the manner of storage of the wine is changed in the manufacturing process, traceability can be improved.

### NFT Correspondence

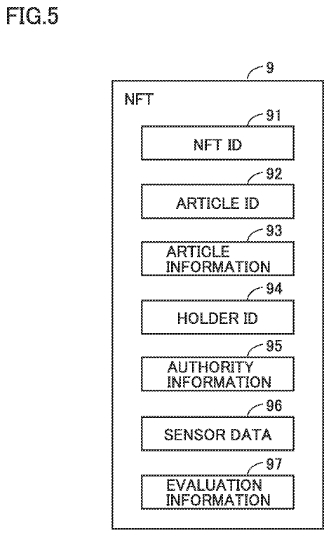

FIG. 5 is a diagram showing an example of a data structure of an NFT according to the present embodiment. The NFT 9 is a material NFT, a barrel NFT or a bottle NFT. The NFT 9 includes, for example, an NFT-ID (Identification) 91, an article ID 92, article information 93, a holder ID 94, authority information 95, sensor data 96, and evaluation information 97. These pieces of information are recorded in the distributed ledger of each node.

The NFT-ID 91 is identification information of the NFT 9. The NFT-ID 91 is any one of a material ID for identifying the material NFT, a barrel ID for identifying the barrel NFT, and a bottle ID for identifying the barrel NFT.

The article ID 92 is identification information of an item associated with the NFT 9 (hereinafter also referred to as “the corresponding item”). The article ID 92 may be, for example, a management number of a container in which materials are accommodated, a management number of a barrel, or a serial number attached to a bottle. The article ID 92 may be managed by a RFID (Radio Frequency IDentification) tag attached to the item.

The article information 93 is information on the corresponding item. When the article is a wine material, the article information 93 may include a variety of materials, a production site, a harvest date, and the like. When the article is a barrel storing wine, the article information 93 may include the name, type, capacity, installation location, installation date, aging period, and the like of the barrel. If the article is a wine-filled bottle, the article information 93 may include the type, volume, bottle-filling location, bottle-filling date, etc. of the bottle.

The holder ID 94 is identification information of the holder of the NFT 9. The owner ID 94 is, for example, an account name of a sender or a purchaser in the NFT market place.

The authority information 95 is information indicating the type of authority that the holder has with respect to the corresponding article. In this embodiment, the authority is the ownership of the article. More specifically, the authorization may be sharing authorization to share an article with other holders for a wine stored in a material stage or barrel. Alternatively, the authority may be proprietary for the bottle- filled wine to explore the article. The authorization may be shared prior to bottling of the wine, whereas it may change to proprietary prior to bottling.

The sensor data 96 is a measurement value for the corresponding article among the measurement values obtained using the sensor system 5. The sensor data 96 may be a measured value itself or a characteristic amount calculated from the measured value. As described above, it is desirable that a time stamp indicating the measurement time is attached to the sensor data 96.

The evaluation information 97 is information indicating quantitative evaluation of the corresponding article (especially wine). In the present embodiment, the evaluation of wine is performed using the evaluation expression 334 (see FIG. 2). The learning system 35 includes a trained evaluation model. The trained evaluation model acquires the ability to calculate the evaluation of the article from the sensor data by machine learning. The evaluation expression 334 defines the relationship between the sensor data and the numerical evaluation (value) of the wine by the machine learning.

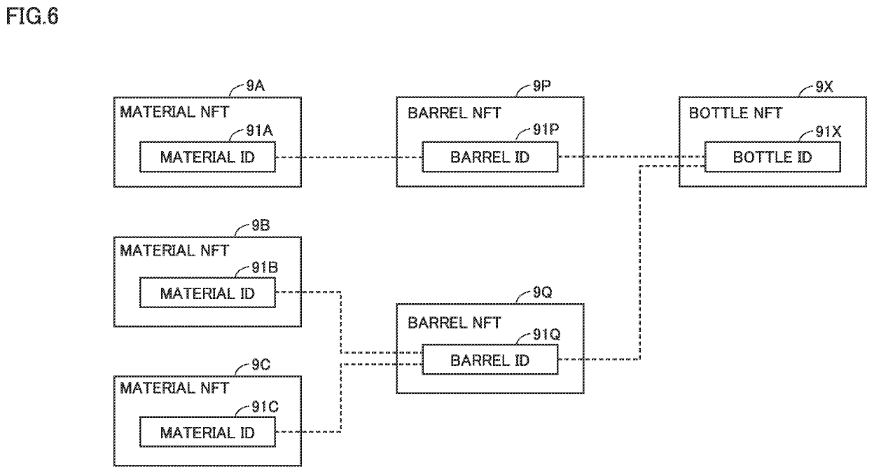

FIG. 6 is a conceptual diagram showing an example of a method of handling the NFT 9 according to the present embodiment. FIG. 6 shows only the NFT-ID 91 (material ID, barrel ID, or bottle ID) among various kinds of information included in the NFT 9 (material NFT, barrel NFT, or bottle NFT) in order to avoid complication of the drawing.

As shown in FIG. 6, the material NFT, the barrel NFT, and the bottle NFT are associated with each other. Material NFT 9A includes material ID 91A, material NFT 9B includes material ID 91B, and material NFT 9C includes material ID 91C. Barrel NFT 9P includes barrel ID 91P and barrel NFT 9Q includes barrel ID 91Q. Bottle NFT 9X includes bottle ID 91X. In this example, the bottle corresponding to the bottle NFT 9X is filled with the wine stored in the barrel corresponding to the barrel NFT 9P and the wine stored in the barrel corresponding to the barrel NFT 9Q. The wine stored in the barrel corresponding to barrel NFT 9P was made from the material corresponding to material NFT 9A. The wine stored in the barrel corresponding to the barrel NFT 9Q is made of the material corresponding to the material NFT 9B and the material corresponding to the material NFT 9C. This ensures traceability for the wine bottled in the bottle corresponding to the bottle NFT 9X.

In this example, the material corresponds to the “first article” according to the present disclosure, and the wine in the barrel corresponds to the “second article” according to the present disclosure. The wine in the barrel corresponds to the “first article” according to the present disclosure, and the bottled wine corresponds to the “second article” according to the present disclosure. Instead of the material NFT, the barrel NFT, and the bottle NFT being associated with each other, the material NFT and the barrel NFT may only be associated with each other. Alternatively, the barrel NFT and the bottle NFT may only be associated with each other.

In the example of FIG. 6, two kinds of NFTs are directly associated with each other. However, when the sensor data 333 is recorded in the distributed ledger network 10, two kinds of NFTs may be associated with each other via the location information (for example, URL) of the associated sensor data 333. The location information of the sensor data 333 may be recorded in the NFT.

### Processing Sequence

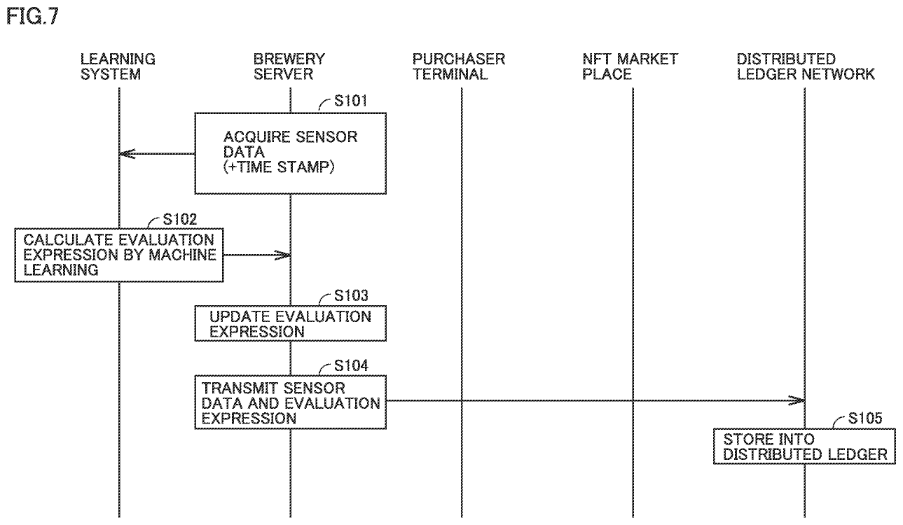

FIG. 7 is a sequence chart showing a processing procedure relating to an evaluation expression for evaluating wine. In the figure, from the left to the right, the processes relating to the learning system 35, the brewery server 3, the purchaser terminal 4, the NFT market place 2, and the distributed ledger network 10 are shown. These processes can be applied to wines (materials, wines in barrels, wines after bottling) in any manner of storage, but the wines in barrels will be described as an example in the following.

In S101, the brewery server 3 transmits the sensor data acquired from the sensor system 5 to the learning system 35 together with the time stamp. This processing may be performed periodically or every time a predetermined amount of sensor data is accumulated.

In S102, when the learning system 35 receives the sensor data from the brewery server 3, the learning system 35 performs machine learning of the relationship between the sensor data and the numerical evaluation (value) of the wine. The machine learning is, for example, supervised learning. The learning system 35 can be given numerical evaluation of wine by a sommelier as correct data. As a machine learning method, a well-known method such as logistic regression, support vector machine, k-nearby method, and decision tree can be adopted. The learning system 35 transmits to the brewery server 3 an evaluation expression obtained as a result of the machine learning (a regression formula for recursively obtaining numerical evaluation of wine from the sensor data).

In S103, the brewery server 3 stores the evaluation expression 334 calculated by the learning system 35 in the storage 33. Thus, the evaluation expression 334 is updated to the latest one. The brewery server 3 transmits sensor data 333 and the latest evaluation expression 334 to the distributed ledger network 10 (S104). Further, the sensor data 333 and the latest evaluation expression 334 is stored in the distributed ledger network 10 (S105).

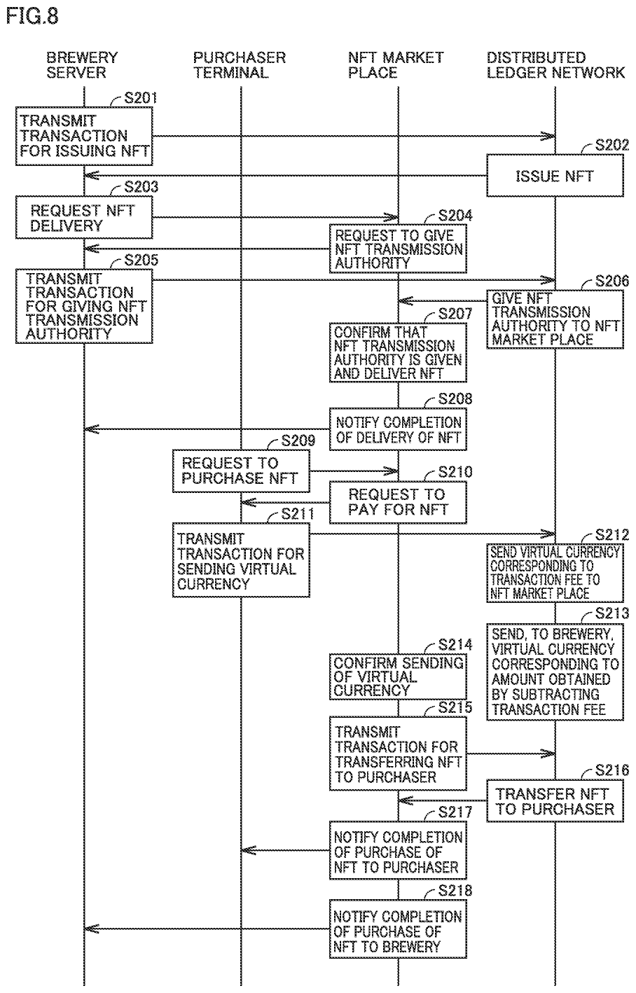

FIG. 8 is a sequence chart showing a processing procedure relating to an NFT transaction. In the figure, from the left to the right, the processing relating to the brewery server 3, the purchaser terminal 4, the NFT market place 2, and the distributed ledger network 10 (one of the nodes 1 in the distributed ledger network 10) is shown. Here, as a typical situation in which the manner of storage of the wine is changed, a situation in which the wine is replaced from the barrel to the bottle is assumed. However, the same applies to the situation in which the wine manufactured from the material is transferred to the barrel.

In S201, the brewery server 3 transmits a transaction for issuing the NFT 9 to the distributed ledger network 10. The distributed ledger network 10 issues an NFT in response to a transaction from the brewery server 3 (S202). The issued NFT is recorded in the distributed ledger network 10.

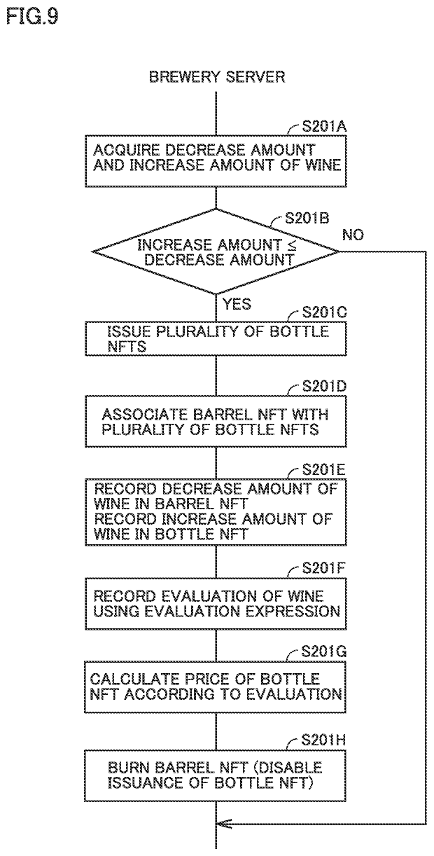

FIG. 9 is a sequence chart showing the NFT issuing process (processing in S201) in more detail. The brewery server 3 may acquire the decrease amount of wine from the barrel and the increase amount of wine packed in a plurality of bottles from the sensor data 96 (measured by the weight sensor 51 and/or the flow rate sensor 52) (S201A). The brewery server 3 may issue a number of bottle NFTs according to the amount of decrease in wine from the barrel and the amount of increase in wine packed in a plurality of bottles (A number of the second non-fungible tokens may be issued according to a decrease amount of the first article and an increase amount of the plurality of second articles.). In other words, the issued bottle NFT may consist of a number of bottle NFTs according to the amount of decrease in wine from the barrel and the amount of increase in wine packed in a plurality of bottles (The issued plurality of second non-fungible tokens may comprise a number of second non-fungible tokens according to a decrease amount of the first article and an increase amount of the plurality of second articles.).

If the time stamp is in the same time zone and the amount of increase (absolute value) of wine packed in a plurality of bottles is larger than the amount of decrease (absolute value) of wine from a barrel, there is a possibility that fraud (so-called dilution) may occur in which different wines are mixed. Therefore, in FIG. 9, as an example, when the increase amount of wine in the same time period of the time stamp is equal to or less than the decrease amount (Typically, the amount of increase in wine is smaller than the amount of decrease and the difference therebetween is smaller than a predetermined amount.) (YES in S201B), the brewery server 3 issues a plurality of bottle NFTs (S201C). The number of issued NFTs corresponds to the amount of decrease in wine from the barrel and the amount of increase in wine bottled into a plurality of bottles. However, the determination of S201B may not be executed. At this time, the brewery server 3 associates the barrel NFT and the plurality of bottle NFTs with each other as described with reference to FIG. 6 (S201D). The brewery server 3 may record the decrease amount of wine from the barrel in the barrel NFT and the increase amount of wine packed in the bottle in the bottle NFT (S201E).

The brewery server 3 may record the evaluation of the bottled wine using the evaluation expression 334 in the bottle NFT as evaluation information 97 (see FIG. 6) (S201F). The brewery server 3 may calculate the price of the bottle NFT according to the evaluation (S201G). The higher the wine evaluation, the higher the price of the bottle NFT.

In some embodiments, the brewery server 3 discards (burns) the barrel NFT (NFT of the empty barrel) when the bottle filling is completed (S201H). That is, the brewery server 3 may discard the barrel NFT in response to the fact that a further bottled wine cannot be obtained from the wine in the barrel as the bottle NFT is issued. Alternatively, the brewery server 3 may add information to the barrel NFT for disabling the issuing of a further bottle NFT. That is, the brewery server 3 may add information for disabling further issuing of the bottle NFT from the barrel NFT to the barrel NFT in response to the fact that a further bottled wine cannot be obtained from the wine in the barrel. For example, the brewery server 3 may set the number of times the flag capable of issuing the bottle NFT from the barrel NFT is used only once. Thus, it is possible to prevent the bottle NFT from being issued to the wine not existing in the barrel.

Referring back to FIG. 8, in S203, the brewery server 3 requests the NFT market place 2 for the NFT delivery. When the NFT market place 2 receives a request from the brewery server 3, the NFT market place 2 requests the brewery server 3 to give an NFT transmission authority (S204).

In S205, the brewery server 3 transmits a transaction for giving the NFT transmission authority to the distributed ledger network 10. In response to the transaction from the brewery server 3, the distributed ledger network 10 gives the NFT transmission authority to the NFT market place 2 (S206).

In S207, when the NFT market place 2 confirms that the NFT transmission authority is given to the NFT market place 2, the NFT market place 2 delivers the NFT designated by the brewery server 3 (S207). Thereby, the NFT can be purchased from the purchaser terminal 4. When the delivery is completed, the NFT market place 2 notifies the brewery server 3 of the completion (S208).

In S209, the purchaser terminal 4 requests the NFT market place 2 to purchase the NFT selected by the purchaser terminal 4. Upon receipt of the request from the purchaser terminal 4, the NFT market place 2 requests the purchaser terminal 4 to pay for the NFT (S210).

In S211, the purchaser terminal 4 transmits a transaction for sending a virtual currency corresponding to a purchase price of the NFT to the distributed ledger network 10. In response to the transaction from the purchaser terminal 4, the distributed ledger network 10 sends the virtual currency corresponding to the transaction fee of the NFT to the NFT market place 2 (S212). In addition, the distributed ledger network 10 sends virtual currency corresponding to the amount obtained by subtracting the transaction fee of the NFT from the total payment amount of the purchaser to the brewery server 3 (S213).

In S214, the NFT market place 2 confirms the sending of the virtual currency in each of the two cases. When the confirmation is made, the NFT market place 2 transmits a transaction for transferring the NFT to the purchaser terminal 4 to the distributed ledger network 10 (S215). In response to the transaction from the NFT market place 2, the distributed ledger network 10 transfers the NFT to the purchaser terminal 4, and notifies the NFT market place 2 of the transfer (S216).

In S217, the NFT market place 2 notifies the purchaser terminal 4 that transfer of the NFT (that is, purchase of the NFT) has been completed. The NFT market place 2 notifies the brewery server 3 that the purchase of the NFT has been completed (S218).

As described above, in the present embodiment, when the manner of storage of the wine is changed, the material NFT, the barrel NFT, and the bottle NFT are made to correspond to each other. This makes it possible to trace the barrel NFT corresponding to the bottle NFT and to trace the material NFT corresponding to the barrel NFT. Therefore, according to the present embodiment, traceability can be improved even when the manner of storage of the wine is changed.

Although the present disclosure has been described and illustrated in detail, it is clearly understood that the same is by way of illustration and example only and is not to be taken by way of limitation, the scope of the present disclosure being interpreted by the terms of the appended claims.

1. A method of managing an non-fungible token for an article, wherein
the article includes a first article and a plurality of second articles,
the plurality of second articles are obtained from the first article by changing a manner of storage of the first article,
the first article is monitored by a first sensor,
each of the plurality of second articles is monitored by a second sensor,
the method comprising:
managing a first non-fungible token (NFT) associated with the first article, the first NFT being issued using distributed ledger technology; and
managing a plurality of second non-fungible tokens (NFTs) respectively associated with the plurality of second articles, the plurality of second NFTs being issued to each correspond to the first NFT using the distributed ledger technology, wherein
the managing of the first NFT includes recording first sensor data obtained by the first sensor, in association with the first NFT, and
the managing of the plurality of second NFTs includes recording second sensor data obtained by the second sensor, in association with the plurality of second NFTs.

2. The method of managing the NFT according to claim 1, further comprising:
in the changing of the manner of storage from the first article to the plurality of second articles, measuring a decrease amount of the first article and an increase amount of the plurality of second articles; and
issuing the second NFTs by a number corresponding to the decrease amount of the first article and the increase amount of the plurality of second articles.

3. The method of managing the NFT according to claim 2, wherein the managing of the first NFT further includes discarding the first NFT in response to a further second article being unable to be obtained from the first article due to the issuing of the plurality of second NFTs.

4. The method of managing the NFT according to claim 2, wherein the managing of the first NFT further includes adding, to the first NFT, information that disables further issuing of a second NFT from the first NFT in response to a further second article being unable to be obtained from the first article.

5. The method of managing the NFT according to claim 1, further comprising:
calculating an evaluation of the first article from the first sensor data using a trained evaluation model; and
calculating a price of the first NFT in accordance with the calculated evaluation, wherein
the trained evaluation model acquired, by machine learning, an ability to calculate an evaluation of an article from sensor data.
